(19) United States
(12) Patent Application Publication
(10) Pub. No.: US 2018/0077910 A1
(43) Pub. Date: Mar. 22, 2018

(54) PRODUCTION OF FREE PEARLS IN ABALONE

(71) Applicant: Universidad de Antofagasta, Antofagasta (CL)

(72) Inventors: Rubén Araya Valencia, Antofagasta (CL); Pedro Saucedo Lastra, La Paz (MX); Alejandro Rojas Figueroa, Antofagasta (CL); Jaime Maturana Zuñiga, Providencia (CL)

(21) Appl. No.: 15/814,987

(22) Filed: Nov. 16, 2017

Related U.S. Application Data
(63) Continuation of application No. PCT/CL2016/000024, filed on May 19, 2016.

(30) Foreign Application Priority Data
May 19, 2015 (CL) 13492015

(51) Int. Cl. A01K 61/51; A01K 63/04

(52) U.S. Cl. CPC A01K 61/51; A01K 63/042

(57) ABSTRACT

The field of application of the method to produce free pearls is in the abalone pearl manufacturing industry. Such process optimizes pearl production, increasing pearl production rate and decreasing toxicity in production processes as well as the abalone mortality rate. The usefulness of the proposed process diversifies the pearl production industry, providing a process applicable to Haliotis rufescens, that enables to produce quality pearls in colors other than the traditional ones and with a more “exotic” character. Consequently, the present invention presents: a method to produce free pearls in abalone, preferably in red abalone Haliotis rufescens, wherein the process comprises the steps of: (a) relaxing the abalone in a tank containing water and CO2; (b) implanting a nucleus in a graft channel of the abalone; (c) inserting a piece of mantle in the graft channel; (d) closing the graft channel; (e) recovering the abalone; and (f) obtaining the pearl.

### CROSS-REFERENCE TO RELATED APPLICATIONS

This application is a continuation of PCT/CL2016/000024, filed May 19, 2016, which claims priority to Chilean Pat. App. No. 1349-2015, filed May 19, 2015, which are incorporated herein by reference.

### TECHNICAL FIELD

The present invention describes a new method to produce free pearls, unattached to the shell, in abalone, preferably red abalone Haliotis rufescens, by using nuclei grafted into graft channels in the visceral mass of the abalone. One key step that provides a differentiating and advantageous element to the invention are a relaxation step, which is carried out by using CO₂ as an anesthetic agent supplied into the water within a tank prior to introducing the abalone, which decreases the toxicity associated with relaxation; and a surgical suture of the graft channel reducing the rejection of grafted nuclei by intervened individuals, optimizing pearl production.

### BACKGROUND

Currently, pearl oyster farming and pearl culture are two of the most profitable aquaculture activities, even above shrimp farming and fish farming, yielding about US$200 million per year.

There are at least two types of pearl culture: (i) free pearl culture, meaning those that do not need to be cut from the shell wall, and reach high commercial value, and (ii) half pearl or mabe culture, which are most commonly produced and are attached to the wall of the shell.

Despite its importance, the pearl production industry is currently facing a market saturation problem worldwide, as pearls are produced only by three species of bivalve mollusks of the Pinctada genus (P. fucata from Japan, P. margaritifera from French Polynesia and P. maxima from Indo-Pacific), which have been overflowing international markets with their pinkish, black and golden colors for decades.

Thus, the need to solve this problem through diversification has prompted pearl producers to seek new mollusk species that produce quality pearls in colors other than the traditional ones and with a more “exotic” character. However, only a few mollusk species qualify, among them the Haliotis sp. abalone and the Caribbean snail Strombus gigas. This is why such diversification process brings a significant competitive edge to the abalone industry in Chile, opening space for opportunity to the industry not only because of its current maturity farming and producing for meat, but also due to the added value the same may get through pearl culture and formation. This is supported by a big pearl market where cultured ones with special characteristics are more attractive, as consumers tend to favor more exotic pearls.

Consequently, the process in the present invention has significant potential to become a relevant innovation mainly due to the high prices reached by cultured free pearls. Additionally, the process is relevant to both domestic and international economies, given that nowadays the cultured abalone meat production industry faces a crisis caused by the decrease in export prices, which results in an inefficient use of infrastructure capacity which could be put to better use by repurposing it for pearl culture, such companies being a natural future client for the technology featured in this invention.

Although industrial activity related to pearl culture has a vast potential for development, in is still emerging Latin America. Between 2004 and 2006, Chile witnessed an experience related to the production of quality half pearls in red abalone Haliotis rufescens that did not have the expected results basically because an invasive method was used to place half nuclei that required piercing the shell, producing much stress and high mortality among the animals.

As can be observed, the pearl production process in the present application shows a clear advantage as compared with the processes in the state of the art, as it decreases toxicity associated with abalone relaxation and optimizes pearl production.

### SUMMARY

According to one general implementation, a method to produce free pearls in abalone includes introducing CO₂ as saturated gas into water within a water tank that has a capacity of 50 to 150 liters, after waiting for a period of about 15 minutes, introducing one or more abalone into the tank containing the water and the CO₂, after waiting for a period of at least 10 minutes but not over 15 minutes, during which the abalone achieve a state of complete relaxation, implanting a nucleus in a graft channel in a visceral mass of the abalone, inserting a piece of mantle, with a nacre secreting face of the mantle placed towards the nucleus, in the graft channel, obtained from the grafted abalone itself or from a donor specimen, closing the graft channel using needle and thread, providing for an initial recovery of the abalone in another tank with seawater and circulating air for 15 to 20 minutes, providing for a final recovery of the abalone in the tank with circulating seawater and abundant aeration for a period of time between 24 to 48 hours, and obtaining the pearls from the abalone.

Various implementations may include one or more of the following features. For example, the abalone relaxation may occur by exposure to the CO₂ present in the water tank. Implanting a nucleus in a graft channel in the visceral mass of the may include identifying the visceral mass in a dorsal-ventral axis of the abalone, opening a graft channel in the identified dorsal-ventral axis of the visceral mass of the abalone, and implanting the nucleus in the graft channel by a grafter, supported over its shell on a graft table, and moving the mantle until the visceral mass area is identified. Opening the graft channel may include preparing an incision using sterile material, and preparing a graft channel opening at least 5 millimeters (mm) and up to 5 millimeters (mm) long using a graft spatula. The graft channel opening may be made in a dorsal orientation of the visceral mass or in a ventral orientation of the visceral mass of the abalone. The implanted nucleus may be 5 to 10 mm in diameter. The shape of the nucleus may be spherical, circular or oval. The piece of mantle may be between 0.15 cm² and 0.5 cm². The pearl may be obtained after a period between 18 to 24 months. The thread may be number 4/0 HR35 (GLICOSORB) of polyglycolic acid.

The details of one or more embodiments of the subject matter described in this specification are set forth in the accompanying drawing and the description below. Other features, aspects, and advantages of the subject matter will become apparent from the description, the drawings, and the claims.

### BRIEF DESCRIPTION OF FIGURES

FIG. 1 illustrates a method to produce pearls in abalone.

A detailed description of the invention will be provided accompanied by the FIGURE that is part of this application.

### DETAILED DESCRIPTION OF THE INVENTION

The pearl production industry faces a market saturation problem, as pearls are produced only by three bivalve molluscs of the Pinctada genus and therefore the search for diversification has prompted pearl producers to seek new species of mollusc capable of producing quality pearls in colors other than the traditional ones. One of the few species of mollusc that meet such criteria is abalone Haliotis sp., with red abalone Haliotis rufescens as a particularly promising option. However, although the pearl culture industry has high potential for development in Chile and in Latin America at large, it is still at an early stage and is constantly looking not only for new species to diversify pearls in the marketplace, but also for pearl production processes that optimize it, improving conditions of mollusk culture, decreasing their mortality rate and increasing the efficiency of pearl production.

Studying the technical problem and its possible solutions resulted in developing the method to produce pearls in abalone of the present invention, which proposes a new option with clear advantages as compared with state of the art processes, as it enables to optimize pearl production by means of two key strategies: improving culture conditions, as it follows a stage of relaxing the abalone that not only helps to reduce its stress, but it is also performed indirectly, that is, by supplying the anesthetic, in this case CO₂ in gas form, into the water tank prior to introducing the abalone, decreasing toxicity associated with relaxation; and improving production efficiency from the step of surgically suturing the incision made to open the graft channel, which decreases graft rejection and therefore improves pearl production efficiency.

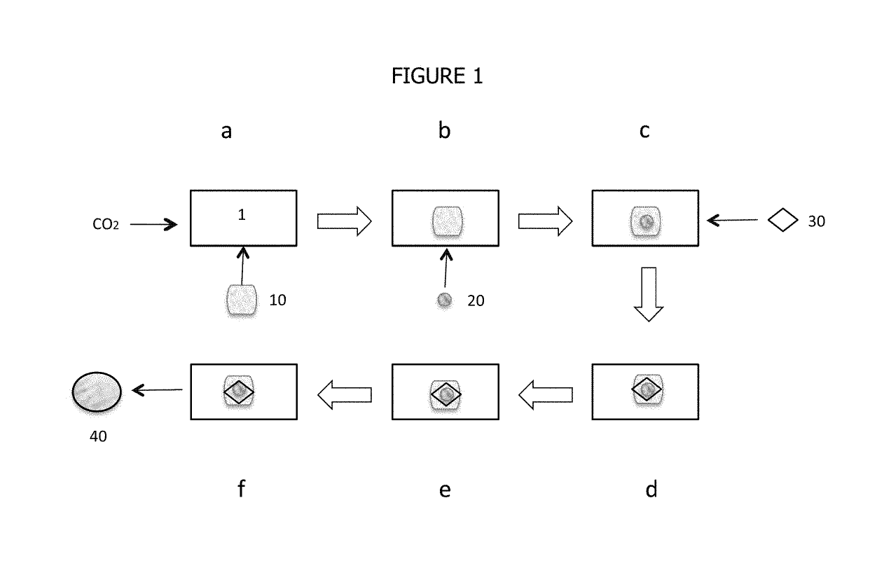

Therefore, the present invention, as shown in FIG. 1, is described as a method to produce pearls in abalone, mainly in red abalone, comprising six steps (a-f), characterized in that it comprises: (a) relaxing the abalone in a tank containing water (1) and CO₂: (b) implanting a nucleus (20) in a graft channel of the abalone (10); (c) inserting a piece of mantle (30) in the graft channel (3); (d) closing the graft channel; (e) recovering the abalone; and (f) obtaining the pearl (40).

For the purposes of understanding the present invention, visceral mass will mean that portion hosting most of the soft tissue of the animal, such as gonad, digestive diverticula, stomach, intestine, among other; which does not include the foot, epipodium, mantle and gills.

The method to produce pearls in abalone of the present invention is carried out in abalone of a size appropriate to produce spherical pearls, which are not limited, but preferably of sizes between 6 and 10 cm, so that inserting nuclei derives in the formation of economically interesting pearls. Regardless of their size, it is also desirable that abalones are in an early gonad development stage, which provides an advantage both from a practical point of view, enabling greater precision in microsurgery, and from an energy point of view, as abalones would not spend too much energy to maturing gamete.

Abalone is relaxed by means of CO₂ as it provides good relaxation and speedy recovery to abalone reducing mortality and damage to the animals' tissue, particularly those with wide contact surface, such as mantle and gills. In this way, the step of relaxing the abalone (a) implies: (i) feeding CO₂ into a water tank (1), which is done as a gas to saturation for a 15 minute period, prior to introducing the mollusc so that the narcotic effect of this gas is quicker, without causing damage to the organism and also reducing the handling of individuals; (ii) introducing the abalone (10) specimens into the tank containing water and CO₂; and (iii) waiting for the period of time necessary for the abalone (10) to be relaxed in order to facilitate its handling and reduce stress and mortality. The water tank wherein the CO₂ is supplied and the abalones subsequently introduced has a capacity ranging between 50 and 150 liters. Preferably, the tank has a 100 liter capacity. On the other hand, waiting time for abalone relaxation is between 10 and 15 minutes, and complete individual relaxation is evidenced by a lack of response or muscular activity by the organism upon touching the mantle or epipodium with a plastic spatula.

The step (b) of implanting a nucleus (20) in a graft channel of the abalone (10) involves: (i) identifying the visceral mass in the abalone's dorsal ventral axis, which is performed by placing the abalone over its shell on a graft table and moving the mantle towards the foot until the zone of visceral mass in the dorsal-ventral axis is identified; (ii) opening a graft channel in the dorsal-ventral axis of the visceral mass of the abalone, comprising: (1) making an incision of at least 5 mm long, even reaching a 10 mm length, using sterile surgical material; and (2) cutting an opening of at least one graft channel in a non-vital area of the abalone, whether in an dorsal orientation of the visceral mass (away from the muscle) or in a ventral orientation of the visceral mass (near the muscle) of the mollusk, using a graft spatula; and (iii) implanting a nucleus (20) of at least 5 mm diameter, not limited to that measurement, at the bottom of the graft channel, which may be, not limited to, of spherical, oval, circular, irregular, asteroidal and other shapes, where implantation of the nucleus is made with a nucleator. Preferably, nuclei are made of bironite.

Preferably, the non-vital region where the opening channels are made is within the dorsal-ventral axis of the animal, at the margin opposite to the posterior part where vents are located, an area in which the foot leaves a gonad-free space and where the graft is subject to low pressure. Preferably, nuclei implantation is made by inserting them in the connective tissue, most preferably from an incision made in the ventral region between the stomach and the hypo-branchial glands.

The step (c) of inserting a piece of mantle (30) in the graft channel implies inserting a piece of mantle (30) that has a portion of the nacre secreting lobe of, but not limited to, 0.15 to 0.5 cm² in diameter in the graft channel, with the nacre secreting face placed towards the nucleus, wherein the piece of mantle comes from the grafted abalone itself or from a donor specimen.

The step (d) of closing the graft channel is carried out though surgical suture using surgical material known as clamp, scissors, scalpel and needle and thread with the purpose of significantly reducing the rejection of grafted nuclei by intervened individuals, which constitutes an improvement to efficiency in pearl production. Preferably, the thread used for suturing is number 4/0 HR35 GLICOSORB (Polyglycolic Acid).

The abalone recovery step (e) is carried out introducing abalones in another tank with seawater and circulating air for a period between 15 and 20 minutes. Subsequently, abalones go through a recovery period in a tank with circulating seawater and abundant aeration. This post surgery process takes 24 to 48 hours and it is vital to ensure that the animal survives the graft miscrosurgery, resumes all vital functions, recovers foot and epipodium motility, and that there is no apparent damage to mantle and branchial tissue, changes in coloring, excessive mucus production, and to ensure grafted nucleus retention.

The step (f) of recovering the pearl (40) is performed for the ultimate purpose to which the whole operational line of the process is aimed, it does not involve high technology, it only requires care and observation for a period of time which will vary between 18 and 24 months since the nucleus is inserted.

In a preferred execution of the present invention, the grafted nucleus is of spherical shape, of 5 to 7 mm in diameter, and the graft channel opening in the dorsal-ventral axis of the abalone visceral mass is made in tissue areas that do not intervene any other vital organs thereof.

As for the market potential that free pearls generated from the method to produce pearls in abalone in the present invention, these could reach prices ranging from USD$100 to USD$600 per piece, depending on their physical characteristics such as shape, luster, surface, nacre thickness and skin.

Shape: Pearl shape will depend both on the shape of the nucleus grafted into the abalone and on the way in which the nacre produced by the piece of mantle deposits on the grafted nucleus, which in turn depends on the spatial arrangement of the nucleus and the piece of mantle. Pearl shape examples include, but are not limited to, half moon, almost spherical or spherical.

Luster: Pearl shine will depend on the nacre deposited on the nucleus and may be considered as, but not limited to, good, very good or high.

Surface: Pearl surface will depend on the nacre deposit on the nucleus and bears relation to how clean the resulting pearl will be. In this regard, the surface of the pearl produced through the method in the present invention may be, but is not limited to, <75% clean, >75% clean or >95% clean.

Nacre thickness: This criterion relates to the amount of nacre deposited from the piece of mantle in the grafted nucleus, which through the method to produce free pearls in the present invention may generate, but is not limited to, a deposit of about 0.25 to 0.35 mm, 0.35 to 0.5 mm or more than 0.5 mm.

Skin: This criterion relates to the imperfections in the pearl surface. According to the method to produce pearls in the present invention, skin may be, but is not limited to, right, good or very good.

The quality of the pearls, the efficiency of the production and the productive advantage of the surgical step is reflected in, but is not limited to, the examples exposed as follows:

### Example 1: Quality of Pearls Produced Following the Process in the Present Invention

The quality of the pearls produced following the process in the present invention will depend at least on the aforementioned physical characteristics and may be, but is not limited to, A quality or low, AA quality or acceptable and AAA or high. An example of specific criteria defining A, AA or AAA quality is detailed as follows:

CHART 1
Quality criteria for pearls produced following
the process in the present invention.

| | SPEHERICAL PEARLS³ | | | |
|---|---|---|---|---|
| | Quality | A | AA | AAA |
| Red | Shape | Half moon | Almost round | Round |
| abalon | Luster | Good | Very good | High |
| | Surface | <75% clean | >75% clean | >95% clean |
| | Nacre | 0.25 to 0.35 | 0.35 to 0.5 | More than 0.5 |
| | | mm | mm | mm |
| | Skin | Right | Good | Very good |

Likewise, other characteristics that may have an influence over the quality or commercial value attributed to a pearl are size and color, assuming that the bigger the size and the more exotic the color, the higher the value of the pearl will be.

### Example 2: Production Efficiency and Quality of Pearls Produced Following the Process in the Present Invention

In a preferred execution of the present invention, the described method to produce pearls in abalone is used in at least three generations of abalone, and to that end the strategy to use the process in the present invention is to perform daily grafting sessions, in which 50 abalones are intervened per grafter, throughout a 5 day week, resulting in 250 grafted abalones per person in 5 days. In a preferred execution, at least three grafters take part, resulting in 750 abalones grafted in a five day period and therefore, 2,250 abalones grafted in the aforementioned generations.

Based on mortality statistics of an average small or early stage pearl farm, and on the process proposed in the present invention, a mortality between 50% and 75% due to handling the abalones is estimated, which considering the pearl production made by three grafters in three generations of abalones, would yield an average production of 750 pearls. Out of this amount, it is estimated that 30% would be A quality (˜225), 50% would be AA quality (˜375) and 20% would be AAA quality (˜150).

### Example 3: Assessing the Step of Closing the Opening Channel Through Surgical Suture in Grafted Animals to Produce Free Pearls

In order to assess the competitive edge of the step of closing the opening channel compared to other processes described in the state of the art, the process in the present invention was followed, including the surgical suture step or not, and graft acceptance or rejection in abalones was assessed. 411 intervened abalones were assessed without closing the opening channel, that is, without a surgical suture done and 154 abalones intervened closing the opening channel through surgical suture.

Results are shown in chart 2.

CHART 2
Abstract of results of the assessment of using surgical
suture in the method to produce pearls in abalone.

| | Acceptance | | | | |
|---|---|---|---|---|---|
| | Intervened | | % | | % |
| | abalones | Accepted | Accepted | Rejected | Rejected |
| Non-sutured | 411 | 261 | 63.50 | 143 | 34.79 |
| animals | | | | | |
| Sutured | 154 | 126 | 81.82 | 28 | 18.18 |
| animals | | | | | |

Based on these results, it can be noted that using surgical suture significantly improves graft acceptance in intervened abalones, which directly results in an increased efficiency in pearl production.

In this way, the present invention shows a new method to produce free pearls in abalone, preferably in red abalone (Haliotis rufescens), intended to bring a solution to the market saturation problem in the pearl culture industry, contributing to diversify through the production of quality pearl in colors other than the traditional ones, following a process that optimizes pearl production in a non-traditional organism such as Haliotis rufescens.

It is worth noting that the FIGURE acts only as a supporting element to better understand the invention, and it does not represent a method to produce free pearls in abalone at a real and/or proportional scale, details of the process in its actual operating condition are also not included, such as: union or connection elements, pumps, filters, etc. Moreover, the invention cannot be limited only to what appears in the FIGURE, as it represents the steps that are important to the invention and elements of public knowledge within the state of the art may not be included. Thus, FIG. 1 represents a diagram of the various steps involved in the method to produce free pearls in abalone according to the present invention.

1. A method to produce free pearls in abalone comprising:
introducing CO₂ as saturated gas into water within a water tank that has a capacity of 50 to 150 liters;
after waiting for a period of about 15 minutes, introducing one or more abalone into the tank containing the water and the CO₂;
after waiting for a period of at least 10 minutes but not over 15 minutes, during which the abalone achieve a state of complete relaxation, implanting a nucleus in a graft channel in a visceral mass of the abalone;
inserting a piece of mantle, with a nacre secreting face of the mantle placed towards the nucleus, in the graft channel, obtained from the grafted abalone itself or from a donor specimen;
closing the graft channel using needle and thread;
providing for an initial recovery of the abalone in another tank with seawater and circulating air for 15 to 20 minutes;
providing for a final recovery of the abalone in the tank with circulating seawater and abundant aeration for a period of time between 24 to 48 hours; and
obtaining the pearls from the abalone.

2. The method to produce free pearls in abalone according to claim 1, wherein the abalone relaxation occurs by exposure to the CO₂ present in the water tank.

3. The method to produce free pearls in abalone according to claim 1, wherein implanting a nucleus in a graft channel in the visceral mass of the comprises:
(i) identifying the visceral mass in a dorsal-ventral axis of the abalone;
(ii) opening a graft channel in the identified dorsal-ventral axis of the visceral mass of the abalone; and
(iii) implanting the nucleus in the graft channel by a grafter, supported over its shell on a graft table, and moving the mantle until the visceral mass area is identified.

4. The method to produce free pearls in abalone according to claim 3, wherein opening the graft channel comprises:
(a) preparing an incision using sterile material; and
(b) preparing a graft channel opening at least 5 millimeters (mm) and up to 10 millimeters (mm) long using a graft spatula.

5. The method to produce free pearls in abalone according to claim 4, wherein the graft channel opening is made in a dorsal orientation of the visceral mass or in a ventral orientation of the visceral mass of the abalone.

6. The method to produce free pearls in abalone according to claim 3, wherein the implanted nucleus is 5 to 10 mm in diameter.

7. The method to produce free pearls in abalone according to claim 6, wherein the shape of the nucleus is spherical, circular or oval.

8. The method to produce free pearls in abalone according to claim 1, wherein the piece of mantle is between 0.15 cm² and 0.5 cm².

9. The method to produce free pearls in abalone according to claim 1, wherein the pearl is obtained after a period between 18 to 24 months.

10. The method to produce free pearls in abalone according to claim 1, wherein the thread comprises number 4/0 HR35 (GLICOSORB) of polyglycolic acid
